(19) United States
(12) Patent Application Publication
(10) Pub. No.: US 2005/0091379 A1
(43) Pub. Date: Apr. 28, 2005

(54) Method and system for initiating session using session initiation protocol under mobile IPv6

(75) Inventors: Pyung-soo Kim, Seoul (KR); Soo-hong Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/915,341

(22) Filed: Aug. 11, 2004

(30) Foreign Application Priority Data
Aug. 12, 2003 (KR) 2003-55869

(51) Int. Cl. G06F 15/16; H04Q 7/00

(52) U.S. Cl. 709/227; 370/328

(57) ABSTRACT

A method and a system for initiating a session with a mobile node using a session initiation protocol under mobile Internet protocol version 6 (IPv6) are provided. The method includes: a caller transmitting a first invite message to an integrated home server; an integrated home server transmitting second location information of a callee to a caller; and the caller directly transmitting a second invite message to the caller using the second location information of the callee.

### BACKGROUND OF THE INVENTION

This application claims the priority of Korean Patent Application No. 2003-55869, filed on Aug. 12, 2003, the disclosure of which is incorporated herein by reference in its entirety.

1. Field of the Invention

The present invention relates to a session initiation method, and more particularly, to a method and system for initiating a session with a mobile node by using a session initiation protocol (SIP) under Internet protocol version 6 (IPv6).

2. Description of the Related Art

The standard of a session initiation protocol (SIP) is generally defined in International Engineering Task Force (IETF) RFC2543 document, according to which the SIP is a control protocol of an application layer to establish, modify and terminate calls or sessions for multimedia communications including pictures or voice. The SIP has been proposed as part of an entire framework, together with session description protocol (SDP: IETF RFC2327), session announcement protocol (SAP: IETF RFC2974), and real-time stream protocol (RTSP: IETF RFC2326), by IETF multiparty multimedia session control (MMUSIC) working group for implementation of a multiparty multimedia communications system. The SIP is a protocol residing on a UDP/TCP/IP layer and a client/server protocol capable of transmitting and receiving an SIP request message and/or an SIP response message in a request/response method. The SIP supports both unicast and multicast so that a session can be initiated by an invitation to a multimedia conference.

As the SIP request message, six basic functions including INVITE (invite to a session), ACK (confirm for INVITE request), BYE (call terminate), REGISTER (user agent registers in the database of a redirect server), CANCEL (cancel a pending request), and OPTIONS (queries, the capabilities of the server) are provided in RFC2543. The SIP response message is a status code and is provided as 1xx (information response), 2xx (successful response), 3xx (redirection response), 4xx (client error, request failure), 5xx (server failure), and 6xx (global failure).

An SIP-based session initiation system comprises an SIP user agent such as a user agent client (UAC) and a user agent server (UAS), and an SIP server such as an SIP proxy server, a redirect server, a location server, and so on.

The SIP user agent has the user agent client (UAC) which is a client application generating and transmitting an SIP request message, and the user agent server (UAS) which is a server application receiving the message and generating and transmitting a response message of accepting, or rejecting the request, or redirecting after changing a reception address. An end terminal on a network should implement these two functions and an application operating with implementation of UAC and UAS is defined as a user agent (UA).

The SIP server is a server application receiving an SIP request and an SIP response from the UA, and is divided into a proxy server and a redirect server for SIP service. The proxy server receives an SIP request from the UA and responds to this or forwards this to a next hop. The proxy server, which receives the SIP request, obtains information to determine a next hop from a location server and transmits the request. The redirect server, which receives an INVITE message to make the other party attend a session, obtains location information from the location server, and then, does not transmit this message to a next hop, but transmits the location information of a receiving party to the UAC (caller) through “302 moved temporarily” response. By doing so, the caller (UAC) can invite the other party desired to communicate with, by directly transmitting an INVITE message.

FIG. 1 is a diagram showing the prior art method for initiating a session by using this SIP in a mobile environment. This technology is disclosed in U.S. Patent No. 2002-191593. In this prior art, in order to efficiently transmit a message, a node such as a home agent (HA) and a foreign agent (FA) on an Internet protocol has a function of an SIP server on the SIP protocol, that is, the function of a proxy server.

The original home network 10 of a callee 200 is samsung.com and the callee 200 has an original SIP address, kps@samsung.com. If the callee 200 moves to a foreign network 20 from the home network 10 in which the callee 200 is originally registered, a new SIP address (kps@mpl.samsung.com) in addition to a new IP address (Care of address, CoA) are given by the proxy server 400 of the foreign network. The callee 200 registers its location by transmitting the new IP address and SIP address to a foreign access node (FAasPS) 400 which functions as a proxy server in the current network 20 in step 101. The foreign access node 400 registers the location information of the callee 200 by transmitting the transmitted new location information to a home access node (HAasPS) 300 functioning as a proxy server in the home network 10 in step 102. By doing so, in the location information database 350 of the home access node 300, the server name (Samsung.com) of the foreign access node 400 to which the callee 200 is currently connected, and the IP address (3ffe:2e01::2a:100:1/64) is stored as in Table 1.

TABLE 1

| Original SIP | | | |
|---|---|---|---|
| address of callee | FAasPS | FAasPS IP address | Caller IP address |
| kps@samsung.com | mpl.samsung.com | 3ffe:2e01:2a:200::1/64 | 3ffe:2e01:2a:222::10 |
| lee@samsung.com | daum.net | 3ffe:2e01:2a:300::1/64 | 3ffe:2e01:2a:333::11 |
| rho@samsung.com | freechal.com | 3ffe:2e01:2a:400::1/64 | 3ffe:2e01:2a:444::12 |
| . | . | . | . |
| . | . | . | . |
| . | . | . | . |

The caller 100 transmits an invite message (INVITE) to the home access node 300 in order to initiate a session with the callee 200 in step 103. This invite message is sequentially transferred to the final callee 200 by the home access node 300 and the foreign access node 400 based on respective location information databases 350 and 450 in steps 104 and 105. The callee 200 who receives the invite message (INVITE) transmits a response message (OK) to the foreign access node 400 in step 106. The foreign access node 400 searches its location information database 450 (Table 2) and transmits the response message (OK) to the home access node 300 of the callee 200 in step 107. Then, the home access node 300 searches its location information database 350 and transmits the response message (OK) to the caller 100 in step 108.

TABLE 2

| SIP address after | | | Mobile Callee IP |
|---|---|---|---|
| callee's moving | HAasPS | HAasPS IP address | address (CoA) |
| kps@mpl.samsung.com | samsung.com | 3ffe:2e01:2a:100::1/64 | 3ffe:2e01:2a:200::10 |
| lee@mpl.samsung.com | korea.com | 3ffe:2e01:2a:500::1/64 | 3ffe:2e01:2a:200::11 |
| rho@mpl.samsung.com | china.com | 3ffe:2e01:2a:600::1/64 | 3ffe:2e01:2a:200::12 |
| . | . | . | . |
| . | . | . | . |
| . | . | . | . |

The caller 100 who receives the response message (OK) transmits a confirmation response message (ACK) to the response message, to the callee 200 in steps 109-111, and this process is performed along the path of caller 100->home access node 300->foreign access node 400->callee 200, as the reverse direction of the transmission direction in the steps 106 through 108. By doing so, a session initiation between the caller 100 and the callee 200 is completed and then, user data transmission begins through the path of caller 100->home access node 300->foreign access node 400->callee 200, and the reverse path.

However, in the session initiation method described above, a case where the callee has to use computer resources irrelevant to the callee itself takes place. This occurs when the computer of the foreign access node of a foreign network which the callee visits belongs to a company (B) which is not to a company (A) providing services to the callee. That is, in this prior art, because of the callee who is a foreign user, the foreign access node should perform a proxy function and as a result, the callee should use the location information database in the foreign access node and therefore the callee should use the resources on a network totally irrelevant to the callee. This is not desirable because it causes a problem of interests in network resources of multiple companies (in relation to this, the current IPv6 specifications define a foreign agent (FA) to perform only the role of a basic router for this).

In addition, since the caller cannot know the new IP address of the callee until binding with the callee is completed, when a session is actually initiated, encapsulation and decapsulation should be repeatedly performed several times between the home access node (HAasPS) and the callee. Accordingly, message transmission is not efficient.

Furthermore, since all message transmission from the caller to the callee should be performed through the home access and the foreign access node, it is not efficient. That is, when there are many callers trying to establish a connection to the caller visiting another network; all the callers should repeatedly perform the message transmission for establishing a call connection such that the communication loads increase in proportion to the number of the callers.

Also, even when the distance (hop) between the caller and the callee is short, message transmission to initiate a session should pass through the home access node and the foreign access node such that the message transmission is inefficient.

### SUMMARY OF THE INVENTION

The present invention provides a method of initiating a session which does not use network resources of a foreign, agent belonging to another administrator, by providing a session initiation method using the foreign agent as a simple router.

The present invention also provides a method of initiating a session capable of more efficient message transmission by enabling a caller to directly transmit a message required for initiating a session to a callee and thus omitting capsulation and decapsulation processes between the caller and the callee.

Consistent with an aspect of the present invention, there is provided a method of initiating a session when a first Internet protocol (IP) address and a first SIP address (first location information) of the callee changes to a second IP address and a second SIP address (second location information), as the callee moves to a second network from a first network, the session initiation method comprising: the caller transmitting an invite message to an integrated home server in transmitting a first invite message; the integrated home server transmitting the second location information of the callee to the caller for reception of second location information; and by using the second location information of the callee, the caller directly transmitting an invite message to the callee in transmitting a second invite message.

Also, the session initiation method further comprises the callee transmitting its second location information to the integrated home server when the callee moves to the second network from the first network for registering the second location information.

Here, the registering of the second location information comprises: a foreign agent (FA) on the second new network periodically advertising the second network information; the callee obtaining the second network information and generating the second location information; and the callee transmitting the generated second location information to the integrated home server.

Also, the second network information includes IP address prefix information (IP prefix) and SIP address suffix information (SIP suffix) of the second network. The FA's advertising is performed by broadcasting Internet control message protocol version 6 (ICMPv6). Transmitting the second location information to the integrated home server is performed by using a binding update message of IPv6 having the second SIP address in an option field.

Also, the transmitting of the second location information to the caller comprises: searching a current location information database deployed in the integrated home server, and in the current location information database, the second location information transmitted by the callee in the registering the second location information is stored.

The registering of the second location information comprises: the callee registering its second location information in a foreign agent of the second network; and the foreign agent transmitting the registered second location information of the callee, to the integrated home server.

Here, the callee's registering second location information comprises: the foreign agent (FA) on the second new network periodically advertising the second network information; the callee obtaining the second network information and generating the second location information; the callee transmitting the generated second location information to the foreign agent; and the foreign agent transmitting the second location information to the integrated home server.

Consistent with another aspect of the present invention, there is provided a communications system for performing session initiation between a caller and a callee who moves from a first network to a second network, through a session initiation protocol (SIP) under IPv6, the communications system comprising: a caller who transmits an invite message to a callee to initiate an SIP session; an integrated home server which receives the invite message from the caller and in response to the message, transmits information on the location of the callee in the second network (second location information) to the caller; and a callee who when visiting the second network from the first network, obtains the second location information from a foreign agent of the second network and transmits the information to the integrated home server, wherein the integrated home server has a second location information database storing the second location information of the callee and the second location information includes a new IP address and a new SIP address of the callee.

Consistent with still another aspect of the present invention, there is provided an integrated home server for performing session initiation between a caller and a callee who moves from a first network to a second network, through a session initiation protocol (SIP) under IPv6, comprising: a second location information database storing second location information of the callee, wherein the integrated home server receives an invite message from the caller and in response to the message, searches the second location information database and transmits second location information of the callee, to the caller.

Here, the integrated home server comprises: an IP server module which receives the second IP address from the callee and updates the current IP address of the second location information database; an SIP server module which receives the second SIP address from the callee and updates the current SIP address of the second location information database; and a transmission module which in response to the invite message of the caller, searches the second location information database and transmits the second location information of a predetermined callee, to the caller.

### BRIEF DESCRIPTION OF THE DRAWINGS

The above aspects and advantages of the present invention will become more apparent by describing in detail exemplary embodiments thereof with reference to the attached drawings in which:

FIG. 1 is a diagram illustrating a method of initiating a session by using a session initiation protocol (SIP) in the prior art mobile environment;

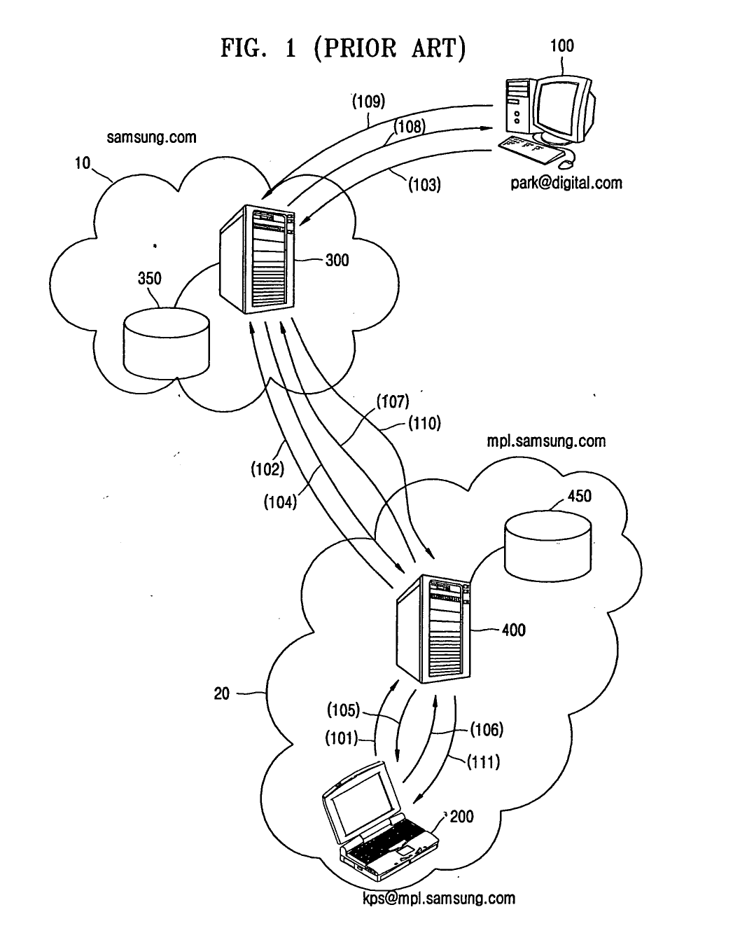

FIG. 2 is a diagram illustrating a method of initiating a session consistent with an exemplary embodiment, of the present invention;

FIG. 3 is a diagram illustrating an internal structure of an integrated home server to implement the session initiation method of FIG. 2;

FIG. 4 is a flowchart of a process for registering new location information in an integrated home server as a callee visits a new network;

FIG. 5 is a diagram of a format of a binding update message used in registering location information;

FIG. 6 is a diagram of the format of an advertise message of a foreign agent;

FIG. 7 is a diagram of the format of a binding update message when the conventional binding message is used in registering location information; and

FIG. 8 is a diagram of the format of a location information message which an integrated home server transmits to a caller.

### DESCRIPTION OF THE EXEMPLARY EMBODIMENTS

The present invention will now be described more fully with reference to the accompanying drawings, in which exemplary embodiments of the invention are shown.

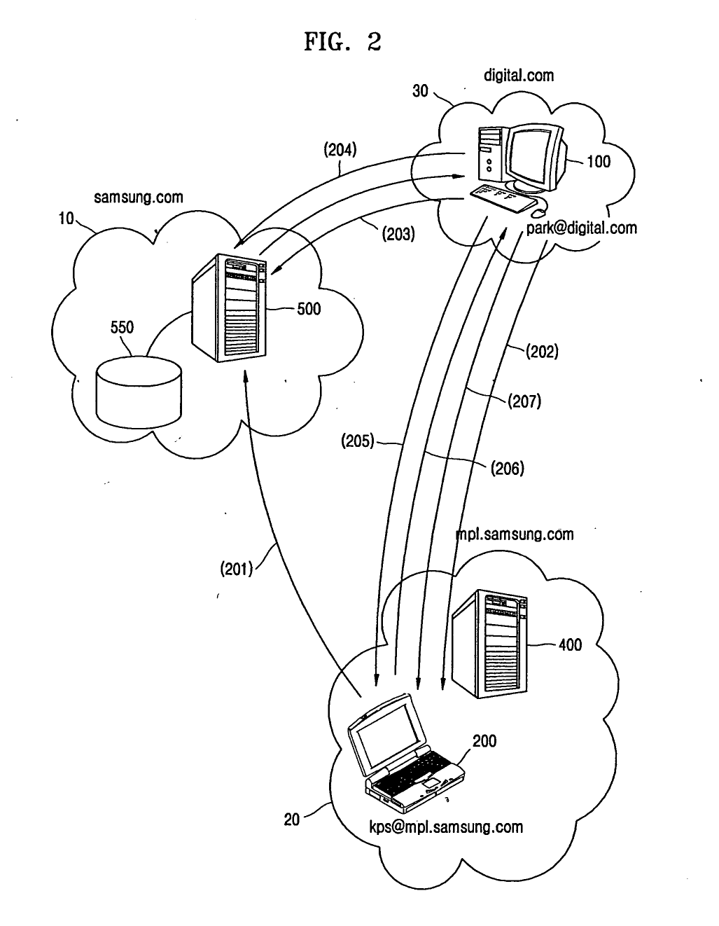

FIG. 2 is a diagram illustrating a method of initiating a session consistent with an embodiment of the present invention.

A caller 100 in network digital.com 30 desires to initiate a session to a callee 200, and the home network of the callee 100 is samsung.com 10 and the network to which the callee is currently connected is mpl.samsung.com 20. Here, digital.com, samsung.com, and mpl.samsung.com indicate the names of networks or servers providing SIP services.

An integrated home server 500 deployed in the home network of the callee 200 is a network node performing characteristic functions in the present invention and has two functions as follows.

First, the integrated home server 500 has a function of mobile IPv6 routing on an Internet protocol layer. Accordingly, it can route all messages having an IPv6 header and functions as a home agent (HA) on a mobile Internet protocol. That is, it manages home addresses (HoA) of mobile nodes (MN) belonging to its network, and if mobile nodes move, receives their foreign addresses (CoA), stores the addresses correspondingly to their home addresses, and transmits the foreign addresses to other mobile nodes requesting them. This binding is implemented in a location information database 550 in the integrated home server 500. Secondly, the integrated home server 500 performs message request and response to initiate a session using the SIP protocol on an application layer. More specifically, after a callee visits a network of another SIP server, the integrated home server 500 receives and stores the location information, that is, a new SIP address, transmitted by the callee, and transmits this new SIP address to a caller requesting this later. Accordingly, it performs a function similar to that of a redirect server or location server among the conventional SIP servers.

A foreign agent 400 is arranged in the network which the callee 200 newly visits, and performs the same function as that of a foreign agent on the conventional mobile IP. Accordingly, it performs mobile IP routing and in order to allow a new mobile node, that is, the callee 200, to generate a new foreign address (CoA), advertises its network information.

A process to initiate a session between the caller 100 and the callee 200 in an exemplary embodiment shown in FIG. 2 will now be explained.

The callee 200 registers new location information in the integrated home server 500 in step 201. More specifically, first, if the callee 200 moves from the original home network 10 to a foreign network 20, the callee 200 receives information on the network 20 from the foreign agent 400 and generates its new location information. The new location information includes a new IP address (a second IP address, 3ffe:2e01:2a:200::10) and a new SIP address (a second SIP address, kps@mpl.samsung.com). Then, the callee 200 transmits the newly generated location information to the integrated home server 500 arranged in the original home network 10, and the integrated home server 500 receiving the information stores the new location information in the location information database 550. By doing so, the registration step (step 201) is finished.

The caller 100 transmits an invite message inviting the callee 200 to the integrated home server 500 in step 202. This is because the caller 100 should transmit an invite message to the SIP server of a home network to which the callee 200 belongs in the prior art SIP session initiation method, and what functions as an SIP server in the present invention is the integrated home server 500. The invite message transmitted by the caller 100 includes the first SIP address (kps@samsung.com) of the callee 200 and the first IP address (3ffe:2e01:2a:100::10). Here, the meaning of “the first” is the location information of the callee 200 before moving to the other network, that is, an address which the caller 100 knows as the location of the callee 200 before the caller 100 receives the new location information from the integrated home server 500.

The integrated home server 500 which receives the invite message of the caller 100 searches the location information database 550 and transmits the corresponding location information of the callee 200 to the caller 100 in step 203. Here, the location information includes the second IP address and the second SIP address recently updated of the callee 200.

The caller 100 who receives the latest location information of the callee 200 transmits a reception acknowledgement message (ACK) for this in step 204, and then, by using the second IP and SIP addresses, directly transmits an invite message to the callee 200 in step 205. Since the destination address in the IPv6 header of this invite message is the second IP address (CoA) of the callee 200, the message can arrive at the callee 200 through ordinary IPv6 routing. This is different from the prior art method using a home address (HoA) as the destination address when a message is transmitted to a callee by a home agent, and as a result, the process of capsulation and decapsulation is not needed.

The callee 200 who receives the invite message transmits an affirmative response message (OK) to the caller 100 in step 206, and the caller 100 who receives the response message, transmits a reception confirmation message to the callee 200 in step 207. By doing so, session initiation between the caller 100 and the callee 200 is finished and then user data are transmitted through ordinary IPv6 routing.

It should be noted that in the above session initiation process, the step 205 for transmitting an invite message to the callee 200 by the caller 100, the step 206 for transmitting an affirmative response message to the invite message, and the step 207 for transmitting a reception confirmation message are all performed through ordinary IPv6 routing. That is, the foreign agent 400 arranged on the routing path between the caller 100 and the callee 200 performs only the function of an IP router and does not perform any operation related to SIP session initiation (for example, searching SIP addresses). This is different from the method disclosed in U.S. Patent No. 2002-191593 by which whenever an SIP message is transmitted between the caller 100 and the callee 200, the foreign agent 400 searches the database 450 in the foreign agent 400 and determines the location of a proxy server 300. That is, consistent with the present invention, when a session is initiated, SIP message transmission between a caller and a callee is performed without capsulation and decapsulation and without using the resources (the database) of the foreign agent 400.

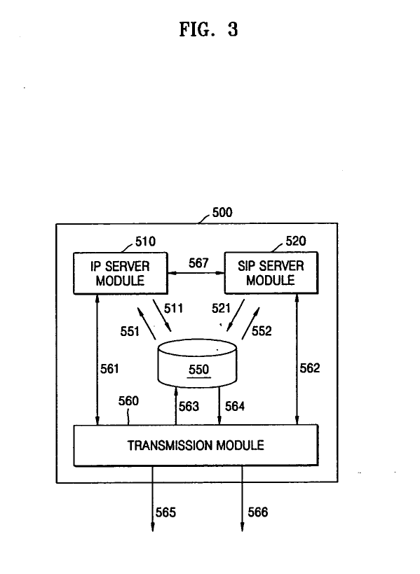

FIG. 3 is a diagram showing the internal structure of an integrated home server to implement the session initiation method of FIG. 2.

Consistent with the characteristics of the present invention, the integrated home server 500 comprises an IP server module 510 which extracts IP information from an SIP message entering the integrated home server 500 and inserts required IP information into an SIP message outflowing from the integrated home server 500; SIP server module 520 which extracts an SIP information from an SIP message entering the integrated home server 500 and inserts required SIP information into an SIP message outflowing from the integrated home server 500; a location information database 550 storing the extracted IP information and SIP information; and a transmission module 560 which transmits an SIP message to and receives an SIP message from a foreign node.

A message entering the integrated home server (path 566) is transmitted to the IP server module 510 by the transmission module 560 (path 561). The IP server module 510 extracts required IP information from the message received through decapsulation and stores the information in the location information database 550 (path 511). The decapsulated message is transferred to the SIP module (path 567) and required SIP information is extracted and is also stored in the location information database 550 (path 521). A message outflowing to the outside from the integrated home server 500 follows the reverse process of the process described above such as decapsulation.

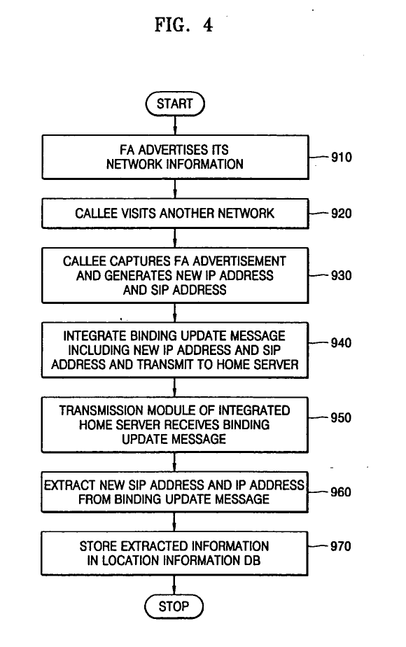

FIG. 4 is a flowchart of a process for registering new location information in an integrated home server as a callee visits a new network. The process is performed by transmitting a modified binding update message and the transmission can be implemented by two methods. The first method is callee's direct transmission of the binding update message to the integrated home server, and the second method is transmission to the integrated home server through a proxy server (foreign agent) as the conventional method.

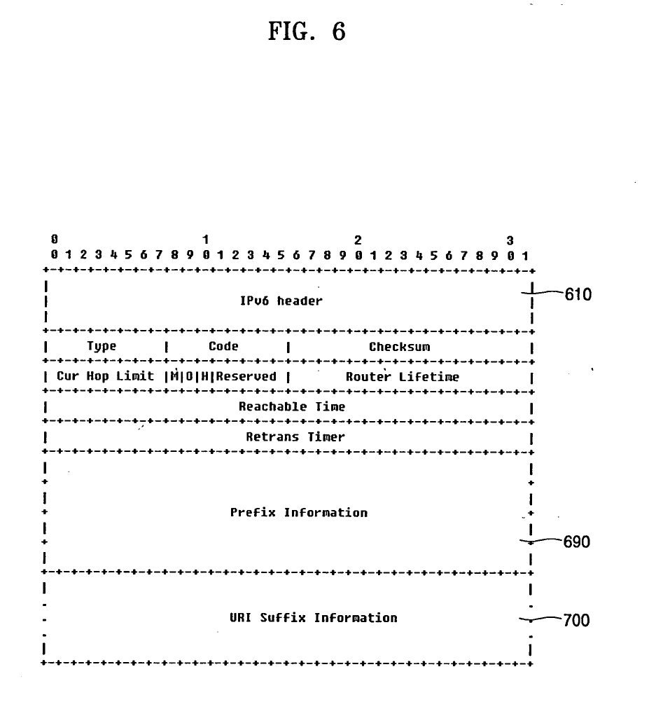

The first method will now be explained. A foreign agent (FA) 400 deployed in each network according to the conventional mobile IPv6 environment advertises its Internet control message protocol (ICMPv6) periodically in step 910. This message format is shown in FIG. 6. However, unlike the conventional ICMPv6 advertising message containing only the prefix 690 of a new network, the ICMPv6 advertising message consistent with the present invention also contains the suffix 700 of a universal resource identifier (URI) of an SIP server included in a new network. This is because the integrated home server 500 functions as a redirect server as well as a home agent and therefore should know information on the SIP server in a new location of the callee.

If the callee 200 visits a new network 20 in step 920, the callee 200 receives the ICMPv6 message and, using prefix information (3ffe:2e01:2a:200) of the new network and suffix information (mpl.samsung.com) of the SIP server included in the ICMPv6 message, generates a new IP address (CoA:3ffe:2e01:2a:200::10) and a new SIP address (kps@mpl.samsung.com) in step 930. At this time, full bits considering the length of the prefix of the network and MAC address are added to the new IP address, and the new SIP address is a value obtained by combining SIP ID, character,@, and the suffix information of the new network.

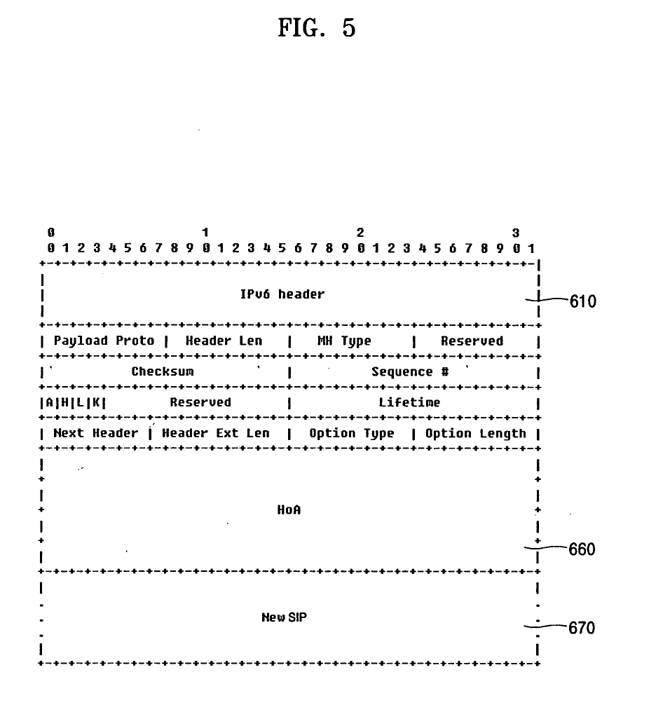

The callee 200 inserts the thus generated second IP address and second. SIP address into a binding update message (BINDING UPDATE) and transmits the message to the integrated home server 500 in step 940. An exemplary biding update message is shown in FIG. 5. Unlike the conventional binding update message, the binding update message consistent with the present invention contains the new SIP address 670 of the callee. In addition, at this time, the new IP address is inserted into the IP header 610 as a source address and the home address 660 inserted as the contents of the message is the first IP address of the callee.

If the transmission module 560 of the integrated home server 500 receives the binding update message in step 950, the IP server module 510 and the SIP server module 520 in the integrated home server 500 extract the second IP address and the second SIP address from the binding update message in step 960 and store them in the location information database 550 in step 970.

By doing so, information on the new location of the callee 200 is updated and this exemplary location information database 550 is shown in Table 3 below. Unlike the conventional binding cache in a home agent providing the home address of a mobile node and the binding table (Table 4) of a foreign address, the location information database 550 in the integrated home server 500 of the present invention contains the SIP addresses (the first SIP address and the second SIP address) in the home network and the new network, in addition to the home address (the first IP address) and the foreign address (the second IP address) of the callee.

TABLE 3

| MNs | Original SIP address | Original IP address | SIP address after moving | IP address after moving |
|---|---|---|---|---|
| Kps | kps@samsung.com | 3ffe:2e01:2a:100::10 | kps@mpl.samsung.com | 3ffe:2e01:2a:200::10 |
| Lee | lee@samsung.com | 3ffe:2e01:2a:100::11 | lee@daum.net | 3ffe:2e01:2a:300::11 |
| Kwon | | 3ffe:2e01:2a:100::50 | | 3ffe:2e01:2a:500::50 |
| Rho | rho@samsung.com | 3ffe:2e01:2a:100::12 | rho@freechal.com | 3ffe:2e01:2a:400::12 |
| . | . | . | . | |
| . | . | . | . | |
| . | . | . | . | |

TABLE 4

| MNs | HoA | CoA |
|---|---|---|
| Kps | 3ffe:2e01:2a:100::10 | 3ffe:2e01:2a:200::10 |
| Lee | 3ffe:2e01:2a:100::11 | 3ffe:2e01:2a:300::11 |
| Rho | 3ffe:2e01:2a:100::12 | 3ffe:2e01:2a:500::12 |
| . | . | . |
| . | . | . |
| . | . | . |

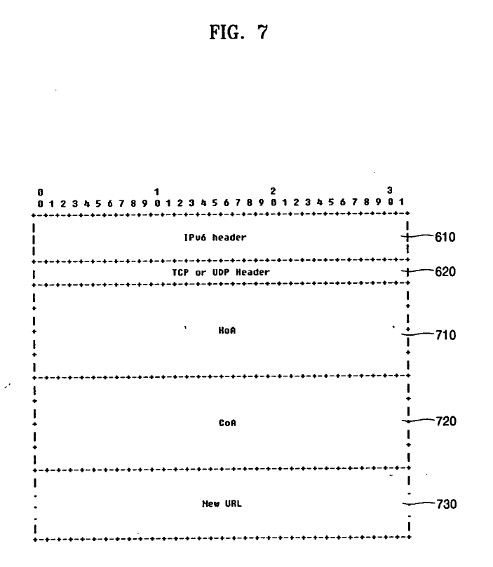

The second method to register the second location information of the callee 200 in the integrated home server 500 is to use the prior art registration message format on the mobile IPv6 as is. This message format is shown in FIG. 7.

According to the conventional registration message format, the first IP address and the second SIP address are inserted into the payload field in TCP/UDP layer 620. The second IP address is inserted in the source address field (not shown) of the IP header.

After the step for registering the new location information of the callee 200, the integrated home server, 500 in response to the invite message transmission of the caller 100, transmits the location information of the corresponding callee to the caller 100.

The IP server module 510 and the SIP server module 520 extract the SIP ID and SIP address of the caller 100 and the SIP ID and the first IP address and the first SIP address of the callee 200, from the invite message of the caller 100 input through the transmission module.

Then, the integrated home server 500 searches location information database 550 based on the extracted information, and transfers information on the new location of the callee 200, that is, the second IP address and the second SIP address of the callee 200, to the transmission module 560, and the transmission module 560 transmits the second IP address and SIP address of the callee 200 to the caller 100.

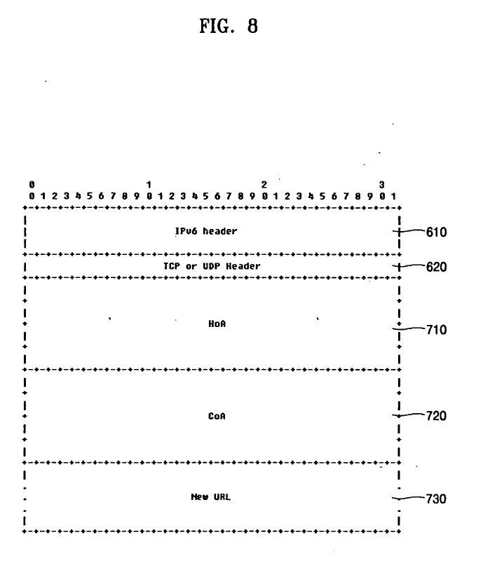

At this time, the integrated home server 500 may use the message format as shown in FIG. 8. According to this message format, the first IP address, the second IP address, and the second SIP address of the callee 200 are arranged in respective payload fields 710, 720, and 730 in TCP/UDP layer. The caller 100 who receives this message transmits a new invite message directly to the callee 200 by using the second IP address of the callee 200.

Accordingly, all messages to initiate a session thereafter, that is, an affirmative response message (OK), and a reception confirmation message (OK), are transmitted directly between the caller 100 and the callee 200 such that session initiation can be performed without capsulation and decapsulation of a message and without separate search of a database by a foreign agent.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

Consistent with the present invention, as described above, a session initiation method using a foreign agent (FA) as a simple router is provided such that a session can be initiated without using the network resources of a foreign agent belonging to another administrator.

Also, by omitting the process of capsulation and decapsulation between a caller and a callee, more efficient message transmission is enabled.

In addition, when there are many callers trying to establish a connection to a callee moving to another network, the transmission of a message, after the location of the callee is learned, does not pass through the integrated home server such that the communication load on the integrated home server functioning as a home agent decreases.

Furthermore, when the distance (bop) between the caller and the callee is short, message transmission for initiating a session does not pass through the home access node and foreign access node such that efficient message transmission is enabled.

1. A session initiation method for communicating user data between nodes under a mobile Internet environment, comprising:
a caller transmitting a first invite message to an integrated home server;
the integrated home server transmitting current location information of a callee to the caller for reception of current location information; and
the caller directly transmitting a second invite message to the callee by using the current location information of the callee.

2. The session initiation method of claim 1, further comprising, when the callee visits a new network, the callee transmitting current location information of the callee to the integrated home server in registering current location information.

3. The session initiation method of claim 2, wherein the registering of current location information comprises:
a foreign agent (FA) on the new network periodically advertising new network information;
the callee obtaining the new network information and generating the current location information; and
the callee transmitting the generated current location information to the integrated home server.

4. The session initiation method of claim 3, wherein the session initiation is performed using Internet protocol version 6 (IPv6).

5. A session initiation method using a session initiation protocol (SIP) under Internet protocol version 6 (IPv6), to initiate a new session for communicating data between a caller and a callee when first location information, including first Internet protocol (IP) address and first SIP address, changes to second location information, including second IP address and second SIP address, as the callee moves to a second network from a first network, the session initiation method comprising:
the caller transmitting a first invite message to an integrated home server;
the integrated home server transmitting the second location information of the callee to the caller for reception of second location information; and
the caller directly transmitting a second invite message to the callee by using the second location information of the callee.

6. The session initiation method of claim 5, further comprising: the callee transmitting its second location information to the integrated home server when the callee moves to the second network from the first network for registering the second location information.

7. The session initiation method of claim 6, wherein the registering of the second location information comprises:
a foreign agent (FA) on the second new network periodically advertising the second network information;
the callee obtaining the second network information and generating the second location information; and
the callee transmitting the generated second location information to the integrated home server.

8. The session initiation method of claim 7, wherein the second network information comprises IP address prefix information (IP prefix) and SIP address suffix information (SIP suffix) of the second network.

9. The session initiation method of claim 7, wherein the FA's advertising is performed by broadcasting Internet control message protocol version 6 (ICMPv6).

10. The session initiation method of claim 7, wherein the transmitting of the second location information to the integrated home server is performed using a binding update message of IPv6 having the second SIP address in an option field.

11. The session initiation method of claim 7, wherein the transmitting of the second location information to the caller comprises searching a current location information database deployed in the integrated home server, and storing, in the current location information database, the second location information transmitted by the callee during the registering.

12. The session initiation method of claim 11, wherein the second location information stored in the current location information database comprises an SIP ID, a first IP address, a first SIP address, a second IP address, and a second SIP address, wherein the SIP ID is an identifier corresponding to a user account of SIP service.

13. The session initiation method of claim 12, wherein the addresses used in the first and second SIP addresses use an email address system.

14. The session initiation method of claim 6, wherein the registering of the second location information comprises:
the callee registering its second location information in a foreign agent of the second network; and
the foreign agent transmitting the registered second location information of the callee, to the integrated home server.

15. An integrated home server for performing session initiation between a caller and a callee who moves from a first network to a second network, through a session initiation protocol (SIP) under IPv6, the integrated home server comprising:
a location information database storing second network location information of the callee, wherein the integrated home server receives an invite message from the caller and in response to the message, searches the location information database and transmits the second network location information of the callee, to the caller.

16. The integrated home server of claim 15, further comprising:
an IP server module which receives a second IP address from the callee and updates a current IP address of the location information database;
an SIP server module which receives a second SIP address from the callee and updates a current SIP address of the location information database; and
a transmission module which in response to the invite message of the caller, searches the location information database and transmits the location information of a predetermined callee, to the caller.

17. The integrated home server of claim 16, wherein the second network location information is generated by advertising of the second network information by a foreign agent of the second network.

18. The integrated home server of claim 17, wherein the second network information comprises IP address prefix information (IP prefix) and SIP address suffix information (SIP suffix) of the second network.

19. The integrated home server of claim 17, wherein the advertising is performed by broadcasting Internet control message protocol version 6 (ICMPv6).
